(19) United States
(12) Patent Application Publication
(10) Pub. No.: US 2007/0072086 A1
(43) Pub. Date: Mar. 29, 2007

(54) Nonaqueous electrolyte cell

(75) Inventor: Hiroe Nakagawa, Takatsuki-shi (JP)

Correspondence Address: PATENTTM.US, P. O. BOX 82788, PORTLAND, OR, 97282-0788, US

(73) Assignee: YUASA CORPORATION, OSAKA (JP)

(21) Appl. No.: 10/556,846

(22) PCT Filed: Mar. 18, 2004
(86) PCT No.: PCT/JP04/03612

§ 371 Date: Nov. 15, 2005

(30) Foreign Application Priority Data
May 15, 2003 (JP) 2003-137867
Jun. 11, 2003 (JP) 2003-166455

(51) Int. Cl. H01M 10/40; H01M 4/52; H01M 4/50

(52) U.S. Cl. 429/330; 429/231.1; 429/223; 429/231.3; 429/224; 429/340; 429/231.8; 429/331

(57) ABSTRACT

It is aimed at providing a nonaqueous electrolyte cell excellent in cell performance in a high-temperature environment. A nonaqueous electrolyte cell comprising a positive electrode and a negative electrode, and produced by using a nonaqueous electrolyte including at least one kind of a cyclic carbonate having a carbon-carbon π bond and at least one kind of a cyclic organic compound having an S═O bond, characterized in

that the positive electrode is constituted of a positive-electrode active material including a main component which is a fired oxide having a layered rock salt type crystal structure represented by Liₘ[Ni_{b}M_{(1-b)}O₂] (M is one or more kinds of elements included in 1 to 16 groups excluding Ni, Li, and O; and 0≦m≦1.1), and in which the value of b is 0<b<1, and

particularly, that the fired oxide has a layered rock salt type crystal structure represented by Liₘ[MnₐNi_{b}Co_{c}O₂] (0≦m≦1.1, a+b+c=1, |a-b|≦0.05, a≠0, b≠0) in which the value of c is 0≦c<1.

### TECHNICAL FIELD

The present invention relates to a nonaqueous electrolyte cell, and particularly to a nonaqueous electrolyte and a positive-electrode active material to be used for a nonaqueous electrolyte cell.

### BACKGROUND ART

Attention has been recently directed to nonaqueous electrolyte cells using various nonaqueous electrolytes capable of obtaining higher energy densities, as electric-power sources for further downsized electronic equipments having higher performances, electric-power sources for electric power storage, electric-power sources for electric vehicles, and the like.

Generally used in a nonaqueous electrolyte cell are: lithium metal oxide as a positive electrode; lithium metal, a lithium alloy, a carbonaceous material or the like for doping and undoping of lithium ions, as a negative electrode; and a nonaqueous electrolyte including an organic solvent and a lithium salt dissolved therein, as an electrolyte. Particularly, those are widely known in which an electrolyte such as lithium hexafluoro phosphate (LiPF₆) or the like is dissolved in a nonaqueous solvent including ethylene carbonate as a main component.

Further, known as lithium metal oxides serving as positive-electrode active materials are complex oxides of lithium and transition metal such as LiCoO₂, LiNiO₂, LiMnO₂, LiMn₂O₄ and the like. Particularly, widely used are lithium cobalt complex oxides represented by LiCoO₂ and the like, among positive-electrode active materials each having an α-NaFeO₂ structure by which higher energy densities are expectable.

One of performances demanded for such nonaqueous electrolyte cells is a charge/discharge cycle performance in a high-temperature environment. Namely, electric-power sources for electronic equipments are frequently used in a high-temperature environment, thereby conventionally causing a problem of a deteriorated cell performance. Particularly, in electric-power sources for electric power storage, electric-power sources for electric vehicles, and the like, there has been caused a severe problem of heat storage due to large-sized batteries, thereby exhibiting a strong demand for a nonaqueous electrolyte cell which is less in performance deterioration even by charge and discharge in a high-temperature environment.

As a nonaqueous electrolyte cell having an excellent cell performance for such a demand, described in a patent literature 1 (JP-A-11-67266) is a cell adopting LiCoO₂ or LiMn₂O₄ for a positive electrode, and-a nonaqueous electrolyte including propylene carbonate, chain carbonate, and vinylene carbonate. Further, described in a patent literature 2 (JP-A-11-162511) is a cell adopting LiCoO₂ as a positive electrode while adopting a solvent including an S═O bond for a nonaqueous electrolyte. Described in a patent literature 3 (JP-A-2002-83632) is a cell adopting LiCoO₂ for a positive electrode, and propylene carbonate, 1,3-propane sultone, and vinylene carbonate as a nonaqueous electrolyte.

However, there remains a problem that charge/discharge cycle performances in a high-temperature environment are not necessarily obtained in a sufficient manner.

### DISCLOSURE OF THE INVENTION

### Problem to be Solved by the Invention

The present invention has been carried out in view of the problem, and it is therefore an object of the present invention to provide a nonaqueous electrolyte cell which is excellent in cell performance in a high-temperature environment.

### Means for solving the Problem

As a result of earnest investigation to solve the above problem, the present inventors have found that the problem can be solved by adopting a specific nonaqueous solvent constituting a nonaqueous electrolyte, and a positive-electrode active material having a specific composition. Namely, the technical configuration of the present invention and functions and effects thereof are as follows. However, presumption is included in terms of mechanisms of actions, and the correctness of the latter never limits the scope of the present invention.

(1) The present invention resides in a nonaqueous electrolyte cell comprising a positive electrode and a negative electrode, and produced by using a nonaqueous electrolyte including at least one kind of a cyclic carbonate having a carbon-carbon π bond and at least one kind of a cyclic organic compound having an S═O bond, characterized in

that the positive electrode is constituted of a positive-electrode active material including a main component which is a fired oxide having a layered rock salt type crystal structure represented by Liₘ[Ni_{b}M_{(1-b)}O₂] (M is one or more kinds of elements included in 1 to 16 groups excluding Ni, Li, and O; and 0≦m≦1.1), and in which the value of b is 0>b<1.

It shall be supposed here that there does not exist a conceptional overlap between the “cyclic carbonate having a carbon-carbon π bond” and the “cyclic organic compound having an S═O bond” to be used for production of the cell of the present invention. Namely, it is supposed that the “cyclic carbonate having a carbon-carbon π bond” does not have an S═O bond.

(2) The nonaqueous electrolyte cell of (1) characterized in that the value of b is 0.08≦b≦0.55.

(3) The nonaqueous electrolyte cell of (2), characterized in that the value of b is 0.25≦b≦0.55.

(4) The nonaqueous electrolyte cell of any one of (1) through (3), characterized in that the M is Mn, or Mn and Co.

(5) The nonaqueous electrolyte cell of (4), characterized in that the fired oxide has a layered rock salt type crystal structure represented by Liₘ[MnₐNi_{b}Co_{c}O₂] (0≦m≦1.1, a+b+c=1, |a-b|≦0.05, a≠0, b≠0) in which the value of c is 0≦c<1.

(6) The nonaqueous electrolyte cell of (5), characterized in that the value of c is 0<c≦0.84.

(7) The nonaqueous electrolyte cell of (6), characterized in that the value of c is 0<c≦0.5.

(8) The nonaqueous electrolyte cell of any one of (1) through (7), characterized in that the cyclic organic compound having an S═O bond has a structure represented by any one of (chemical formula 1) through (chemical formula 4):

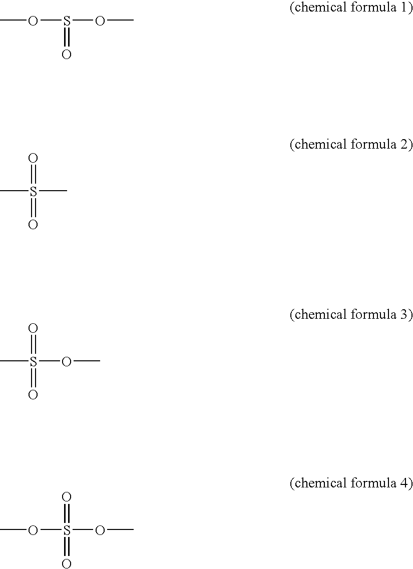

(9) The nonaqueous electrolyte cell of (8), characterized in that the cyclic organic compound having an S═O bond is at least one kind selected from among ethylene sulfite, propylene sulfite, sulfolane, sulfolene, 1,3-propane sultone, 1,4-butane sultone, and derivatives thereof.

(10) The nonaqueous electrolyte cell of any one of (1) through (9), characterized in that the cyclic carbonate having a carbon-carbon π bond is at least one kind selected from among vinylene carbonate, styrene carbonate, catechol carbonate, vinylethylene carbonate, 1-phenylvinylene carbonate, and 1,2-diphenylvinylene carbonate.

(11) The nonaqueous electrolyte cell of any one of (1) through (10), characterized in that the nonaqueous electrolyte includes a cyclic carbonate without carbon-carbon π bonds.

(12) The nonaqueous electrolyte cell of (11), characterized in that the cyclic carbonate without carbon-carbon π bonds is at least one kind selected from among ethylene carbonate, propylene carbonate, and butylene carbonate.

(13) The nonaqueous electrolyte cell of any one of (1) through (12), characterized in that the main component of the negative-electrode active material constituting the negative electrode is graphite.

### Effect of the Invention

According to the present invention, there can be provided a nonaqueous electrolyte cell excellent in cell performance in a high-temperature environment.

### BRIEF DESCRIPTION OF THE DRAWINGS

FIG. 1 is a cross-sectional view of a nonaqueous electrolyte cell used in each Example.

FIG. 2 is a graph of high-temperature charge/discharge cycle performances of inventive cells and comparative cells.

FIG. 3 is another graph of high-temperature charge/discharge cycle performances of inventive cells and comparative cells.

### EXPLANATION OF REFERENCE NUMERALS

1 positive electrode
11 positive electrode composite
12 positive electrode current collector
2 negative electrode
21 negative electrode composite
22 negative electrode current collector
3 separator
4 electrode group
5 metal/resin laminate film

### BEST MODE FOR CARRYING OUT THE INVENTION

Fired oxides to be used as positive-electrode active materials of the present invention, respectively, are preferably represented by a general formula Liₘ[Ni_{b}M_{(1-b)}O₂] where M is one or more kinds of elements, which are included in 1 to 16 groups excluding Ni, Li, and O, and which are substitutable for Ni. For example, examples thereof include Be, B, V, C, Si, P, Sc, Cu, Zn, Ga, Ge, As, Se, Sr, Mo, Pd, Ag, Cd, In, Sn, Sb, Te, Ba, Ta, W, Pb, Bi, Co, Fe, Cr, Mn, Ti, Zr, Nb, Y, Al, Na, K, Mg, Ca, Cs, La, Ce, Nd, Sm, Eu, Tb, and the like, without limited thereto. These may be used solely, or combinedly in two or more kinds. Particularly, selection of M from among V, Al, Mg, Mn, Co, Cr, and Ti, is more preferable by virtue of obtainment of a particularly remarkable effect in high-rate discharge performance.

It is particularly desirable that the M is established by adopting Mn, or Mn and Co as main elements in a manner as used in Examples to be described later, in that excellent charge/discharge cycle performances can be exhibited then. In this case, it is further desirable that an atomic ratio of Mn and Ni is 1:1. Thus, desirable are fired oxides represented by a composition formula Liₘ[MnₐNi_{b}Co_{c}O₂] where |a-b|≦0.05, in consideration of errors during production of fired oxides.

Addition of small amounts of elements such as Al, In, Sn, and the like as the M, is desirable by virtue of an increased stability of a crystal structure. In this case, it is desirable that a ratio of elements such as Al, In, Sn, and the like in [Ni_{b}M_{(1-b)}O₂] is 0.1 or less.

Examples of methods for introducing an element M into a fired oxide during a synthesis step thereof, include a method for previously adding an element as a substituent into a starting material for an active material, and a method for firing LiNiO₂ and then substituting different elements therefor such as by ion-exchange, without limited thereto.

The contents of the carbonates each having a carbon-carbon π bond and cyclic organic compounds each having an S═O bond, are preferably 0.01 wt. % to 20 wt. % in total relative to a total weight of nonaqueous electrolyte, more preferably 0.10 wt. % to 10 wt. % in total. When the contents of the carbonates each having a carbon-carbon π bond and cyclic organic compounds each having an S═O bond are 0.01 wt. % or more in total relative to the total weight of the nonaqueous electrolyte, it becomes possible to substantially perfectly restrict decomposition of other organic solvents constituting the nonaqueous electrolyte at the time of first charge, thereby conducting the charge more assuredly. Further, by virtue of the contents of 20 wt. % or less in total, there is hardly caused deterioration of a cell performance due to decomposition, on the positive electrode, of excessively contained carbonates each having a carbon-carbon π bond and cyclic organic compounds each having an S═O bond, thereby enabling exhibition of a sufficient cell performance. Note that although the content ratio of the carbonates each having a carbon-carbon π bond and cyclic organic compounds each having an S═O bond, can be arbitrarily selected, weight ratios of about 1:1 are preferable.

Usable as an organic solvent constituting the nonaqueous electrolyte is one to be typically used in a nonaqueous electrolyte for a nonaqueous electrolyte cell. Examples thereof include a single or a combination of two or more kinds selected from: cyclic carbonates such as propylene carbonate, ethylene carbonate, butylene carbonate, and chloroethylene carbonate; cyclic esters such as γ-butyrolactone, γ-valerolactone, and propiolactone; chain carbonates such as dimethyl carbonate, diethyl carbonate, ethyl methyl carbonate, and diphenyl carbonate; chain esters such as methyl acetate, and methyl butyrate; ethers such as tetrahydrofuran or derivatives thereof, 1,3-dioxane, dimethoxyethane, diethoxyethane, methoxyethoxyethane, and methyldiglyme; and nitrites such as acetonitrile and benzonitrile; without limited thereto. Further, it is also possible to adopt phosphate ester which is a flame-resistant solvent to be typically added to a liquid electrolyte for a nonaqueous electrolyte cell. For example, examples thereof include trimethyl phosphate, triethyl phosphate, ethyldimethyl phosphate, diethylmethyl phosphate, tripropyl phosphate, tributyl phosphate, tri(trifluoromethyl)phosphate, and tri(trifluoroethyl)phosphate, without limited thereto. These may be used solely, or combinedly in two or more kinds.

Note that it is preferable in the present invention to further contain a cyclic carbonate without carbon-carbon π bonds and having a higher dielectric constant, in the nonaqueous electrolyte, since the effect of the present invention can be sufficiently exhibited then. It is desirable here that the cyclic carbonate without carbon-carbon π bonds is selected from among those having boiling points of 240° C. or higher. It is particularly desirable that such a carbonate contains at least one kind selected from a group consisting of ethylene carbonate, propylene carbonate, and butylene carbonate. Here, it is desirable that the ratio of the cyclic carbonate without carbon-carbon π bonds to the nonaqueous electrolyte, is 30 vol. % or more.

The lithium salt constituting the nonaqueous electrolyte is not particularly limited, and it is possible to use those lithium salts which are each stable over a wide electric potential range to be typically used for a nonaqueous electrolyte cell. Examples thereof include LiBF₄, LiPF₆, LiClO₄, LiCF₃SO₃, LiN(CF₃SO₂)₂, LiN(C₂F₅SO₂)₂, LiN(CF₃SO₂) (C₄F₉SO₂) , LiC(CF₃SO₂)₃, and LiC(C₂F₅SO₂)₃, without limited thereto. These may be used solely, or combinedly in two or more kinds. Note that it is more preferable to combiningly use an inorganic lithium salt such as LiPF₆ or LiBF₄ and an organic lithium salt having a perfluoroalkyl group such as LiN(CF₃SO₂)₂ and LiN(C₂F₅SO₂)₂, because of an effect for improving a high-temperature storage performance.

Concentrations of lithium salts in nonaqueous electrolytes are preferably 0.1 mol/L to 5 mol/L, and more preferably 1 mol/L to 2.5 mol/L, so as to assuredly obtain a nonaqueous electrolyte cell having higher cell characteristics.

Examples of a negative-electrode active material as a main component of a negative electrode, include: carbonaceous material; metal oxides such as tin oxide, and silicon oxide; and materials obtained by adding phosphorus, boron or the like to the former material for modification thereof, for the purpose of improving a negative electrode characteristic. Among the carbonaceous materials, graphite is preferable as a negative-electrode active material, since graphite has an operation voltage extremely closest to that of metal lithium so that adoption of lithium salt as an electrolyte salt enables a decreased self-discharge and enables a decreased irreversible capacity in charge and discharge. Further, used in the present invention is the nonaqueous electrolyte containing the cyclic carbonates each having a carbon-carbon π bond and cyclic organic compounds each having an S═O bond, thereby enabling assured restriction of decomposition of the other organic solvents constituting the nonaqueous liquid electrolyte on the negative electrode including graphite as its main component at the time of charge, to thereby assuredly allow expression of the above-mentioned advantageous characteristics of graphite.

Shown below are analysis results of preferably usable graphites, by X-ray diffractometry, for example:

Lattice spacing (d002): 0.333 to 0.350 nanometer

Crystallite size La in a-axis direction: 20 nanometers or larger

Crystallite size Lc in c-axis direction: 20 nanometers or larger

True density: 2.00 to 2.25g/cm³

It is possible to modify graphite by adding thereto a metal oxide such as tin oxide or silicon oxide, phosphorus, boron, amorphous carbon, or the like. Particularly, modification of a surface of graphite by the above-mentioned method is possible and desirable since decomposition of a liquid electrolyte can be thereby restricted to enhance cell characteristics. Further, as a negative-electrode active material, it is also possible to use graphite combined with lithium metal, or a lithium metal-containing alloy such as lithium-aluminum, lithium-lead, lithium-tin, lithium-aluminum-tin, lithium-gallium, or Wood's metal, and to use graphite including lithium previously inserted therein by electrochemical reduction.

In addition to the above-mentioned active materials as main components, usable for a positive electrode and a negative electrode are those obvious ones in the technical field as required in obvious formulations, such as an electroconductive material, a binder, and a current collector.

Electroconductive materials are not particularly limited insofar as they are electron-conductive materials without bad influence on cell characteristics, and can be provided by including one or more kinds or a mixture of natural graphite (e.g., vein graphite, flake graphite, or amorphous graphite), artificial graphite, carbon black, acetylene black, Ketjen Black, carbon whiskers, carbon fibers, metal (e.g., copper, nickel, aluminum, silver, gold, and the like) powders, metal fibers, and electroconductive ceramic materials.

Among them, acetylene black is desirable as an electroconductive material from the standpoints of electroconductivity and applicability in coating. Addition amounts of an electroconductive material are preferably from 1 wt. % to 50 wt. %, more preferably 2 wt. % to 30 wt. % relative to a total weight of a positive electrode or negative electrode. Mixing manners of them are physical, so that homogeneous mixing is ideal. It is thus possible to attain the mixing in a wet or dry manner by a powder mixer such as a V-type mixer, S-type mixer, mortar mill, ball mill, or planetary ball mill.

Note that it is also possible to modify at least surface portions of particles of positive-electrode active material and particles of negative-electrode active material, by a compound excellent in electron conductivity or ionic conductivity, or having a hydrophobic group. Examples of the modification include coating of: a material having an excellent electron conductivity such as gold, silver, carbon, nickel, and copper; a material having an excellent ionic conductivity such as lithium carbonate, boron glass, solid electrolyte; or a material having a hydrophobic group such as silicone oil; by utilizing a technique such as plating, sintering, mechano-fusion, vapor deposition, or baking.

The powder of the positive-electrode active material and the powder of the negative-electrode active material desirably each have an averaged particle size of 100 μm or less. Particularly, it is desirable that the averaged particle size of the powder of the positive-electrode active material is 10 μm or less to improve the high-output characteristics of the nonaqueous electrolyte cell. There are used a pulverizer and a classifier for obtaining particles in predetermined shapes. There are exemplarily used a mortar, ball mill, sand mill, oscillating ball mill, planetary ball mill, jet mill, counter jet mill, or cyclone type jet mill, sieves, and the like. Pulverization may be conducted by wet pulverization with coexistence of water or organic solvent such as hexane. Methods of classification are not particularly limited, and sieves, air classifiers, and the like are used in each of dry and wet processes as required.

Usable as the binder in a mixture form of one or two or more kinds, are: thermoplastic resins such as polytetrafluoroethylene, polyvinylidene fluoride, polyethylene, and polypropylene; polymers having rubber elasticity, such as ethylene/propylene/diene terpolymers (EPDM), sulfonated EPDM, styrene/butadiene rubbers (SBR), and fluororubbers; and polysaccharides such as carboxymethyl cellulose. Further, in adopting a binder such as polysaccharides having a functional group reactive with lithium, it is desirable to inactivate the functional group such as by methylation. The adding amount of the binder is preferably 1 to 50 wt. %, more preferably 2 to 30 wt. % relative to the total weight of a positive electrode or negative electrode.

The positive-electrode active material or negative-electrode active material, the electroconductive material, and the binder are kneaded by adding an organic solvent such as toluene or water thereto, and formed into an electrode shape followed by drying, thereby enabling preferable fabrication of a positive electrode or negative electrode.

It is desirable that the positive electrode and negative electrode are configured to be closely contacted with a positive electrode current collector and a negative electrode current collector, respectively. For example, usable as the positive electrode current collector are aluminum, titanium, stainless steel, nickel, fired carbon, conductive polymer, conductive glass, and the like, as well as those provided by treating a surface of aluminum, copper, or the like with carbon, nickel, titanium, silver, or the like for the purpose of improving adhesiveness, electroconductivity, and oxidation resistance. Usable as the negative electrode current collector are copper, nickel, iron, stainless steel, titanium, aluminum, fired carbon, conductive polymer, conductive glass, Al—Cd alloy, and the like, as well as those provided by treating a surface of copper or the like with carbon, nickel, titanium, silver, or the like for the purpose of improving adhesiveness, electroconductivity, and oxidation resistance. These materials can be subjected to a surface oxidation treatment.

With respect to the shape of the current collector, there are used a foil form, and a film, sheet, net, punched or expanded, lath, porous, or foamed form, as well as a structure made of fiber group. Although the thickness thereof is not particularly limited, collectors having a thickness of 1 to 500 μm are used. Among them, desirably usable as a positive electrode current collector is an aluminum foil excellent in oxidation resistance; and desirably usable as a negative electrode current collector are a copper foil, nickel foil, iron foil, and alloy foil containing part thereof, which are stable in a reduction field, excellent in electroconductivity, and inexpensive. Furthermore, these foils are to preferably have a rough-surface of a surface roughness Ra of 0.2 μm or more, thereby achieving an excellent adherence of a positive electrode or a negative electrode to a current collector. It is therefore most preferable to use an electrolytic foil having such a rough surface. It is most preferable to use an electrolytic foil which has undergone a “hana” surface treatment.

Usable as a nonaqueous electrolyte cell-oriented separator are a fine porous membrane, nonwoven fabric, and the like which are obvious in this technical field, in obvious formulations. It is also possible to use a polymer solid electrolyte or gel electrolyte as a nonaqueous electrolyte, thereby simultaneously exhibiting a function of the separator. It is further possible to use a polymer solid electrolyte or gel electrolyte together with the separator such as the fine porous membrane, nonwoven fabric, and the like.

It is preferable to solely or combiningly use a fine porous membrane, nonwoven fabric or the like exhibiting an excellent rate characteristics, as a nonaqueous electrolyte cell-oriented separator. Examples of the material constituting the nonaqueous electrolyte cell-oriented separator include: polyolefin resins represented by polyethylene and polypropylene; polyester resins represented by polyethylene terephthalate and polybutylene terephthalate; and polyvinylidene fluoride, vinylidene fluoride/hexafluoropropylene copolymers, vinylidene fluoride/perfluorovinyl ether copolymers, vinylidene fluoride/tetrafluoroethylene copolymers, vinylidene fluoride/trifluoroethylene copolymers, vinylidene fluoride/fluoroethylene copolymers, vinylidene fluoride/hexafluoroacetone copolymers, vinylidene fluoride/ethylene copolymers, vinylidene fluoride/propylene copolymers, vinylidene fluoride/trifluoropropylene copolymers, vinylidene fluoride/tetrafluoroethylene/hexafluoropropylene copolymers, and vinylidene fluoride/ethylene/tetrafluoroethylene copolymers.

The porosity of the nonaqueous electrolyte cell-oriented separator is preferably 98 vol. % or lower from the standpoint of strength. The porosity is preferably 20 vol. % or higher from the standpoint of charge/discharge characteristics.

Usable as the nonaqueous electrolyte cell-oriented separator are a polymer gel constituted of a liquid electrolyte including therein a polymer such as acrylonitrile, ethylene oxide, propylene oxide, methyl methacrylate, vinyl acetate, vinylpyrrolidone, polyvinylidene fluoride, or the like.

Further, it is desirable to combiningly use the above-mentioned porous membrane, nonwoven fabric or the like and the polymer gel as the nonaqueous electrolyte cell-oriented separator, because of an improved retentivity of a liquid electrolyte. Namely, surfaces of a fine porous polyethylene membrane and walls of micropores thereof are formed thereon with a film having a thickness of several micrometers or less and being provided by coating of a solvent-philic polymer while holding a liquid electrolyte within the micropores of the film, so that the solvent-philic polymer is brought into a gel state.

Examples of the solvent-philic polymer include polyvinylidene fluoride, and polymers formed by crosslinking of an acrylate monomer having an ester group, an ethylene oxide group, or the like, an epoxy monomer, or monomer having an isocyanate group, and the like. In cross-linking, it is possible to utilize heating, an active light source such as ultraviolet light (UV), electron beam (EB), and the like.

The nonaqueous electrolyte cell according to the invention is preferably fabricated by injection of a liquid electrolyte before or after stacking of a nonaqueous electrolyte cell-oriented separator, a positive electrode, and a negative electrode, followed by final sealing by a sheathing material. In a nonaqueous electrolyte cell including a wound power generation element including stacked positive electrode and negative electrode through a nonaqueous electrolyte cell-oriented separator therebetween, it is preferable to inject a liquid electrolyte into the power generation element before or after the winding. Although the injection may be conducted at an ordinary pressure, it is possible to use vacuum impregnation, pressure impregnation, and the like.

Usable as a sheathing body are those which are obvious in this technical field, in obvious formulations, such as metal can, metal/resin laminate material, and the like. Thinner materials are preferable from a standpoint of a light-weighted nonaqueous electrolyte cell, and it is preferable to use a metal/resin laminate film having a constitution comprising resin films and a metal foil interposed therebetween, for example. Examples of the metal foil are not particularly limited as long as they are foils of aluminum, iron, nickel, copper, stainless steel, titanium, gold, silver, or the like which are free of pinholes. However, aluminum foils are preferred because they are light-weight and inexpensive. Preferably usable as the resin film to be disposed on the outer side in the cell is a resin film having excellent piercing strength, such as a polyethylene terephthalate film or nylon film, and preferably usable as the resin film to be disposed on the inner side in the cell is a film which is fusion-bondable and has solvent resistance, such as a polyethylene film or nylon film.

The present invention will be described hereinafter in detail with reference to Examples, and the present invention is not limited by such a description.

### EXAMPLE 1

There will be firstly explained a method for producing a fired oxide having a layered rock salt type crystal structure to be used for the cell of the present invention, taking a method for obtaining an LiMn_{0.42}Ni_{0.42}Co_{0.16}O₂ composition, for example.

Introduced into a closed type reaction vessel was 3.5 liters of water. Further, 32% aqueous sodium hydroxide solution was added thereto to establish a pH of 11.6. Stirring was conducted by a stirrer having paddle type stirring blades at a rotational speed of 1,200 rpm, and the temperature of the solution in the reaction vessel was kept at 50° C. by an external heater. Furthermore, argon gas was blown into the solution within the reaction vessel to remove oxygen dissolved in the solution.

Meanwhile, there was prepared an aqueous solution including transition metal elements dissolved therein as a starting material solution. It was obtained by mutually mixing an aqueous manganese sulfate pentahydrate solution, an aqueous nickel sulfate hexahydrate solution, an aqueous cobalt sulfate heptahydrate solution, and an aqueous hydrazine monohydrate solution, in a manner to achieve a manganese concentration of 0.738 mol/L, a nickel concentration of 0.738 mol/L, a cobalt concentration of 0.282 mol/L, and a hydrazine concentration of 0.0101 mol/L.

The starting-material solution was continuously dropped into the reaction vessel at a rate of 3.17 mL/min. Synchronizedly therewith, 12 mol/L aqueous ammonia was dropped at a rate of 0.22 mL/min. Furthermore, 32% aqueous sodium hydroxide solution was intermittently introduced into the solution in the reaction vessel so as to keep the pH of the solution constant at 11.4±0.1. Further, the temperature of the solution within the reaction vessel was intermittently controlled by the heater so that the temperature was kept constant at 50° C. Moreover, argon gas was directly blown into the reaction vessel to achieve a reducing atmosphere therein. The resultant slurry was discharged from the system with a flow pump so as to always keep the solution volume constant at 3.5 liter. During a period of 5 hours from a time point after a lapse of 60 hours from starting of the reaction, there was collected a slurry of Ni—Mn—Co complex oxide as a crystallization product of reaction. The collected slurry was washed with water, filtered, and dried at 80° C. overnight to obtain a dry powder of an Ni—Mn—Co coprecipitated precursor.

The obtained Ni—Mn—Co coprecipitated precursor powder was sieved to a size less than 75 μm, and the thus obtained matter and a powder of lithium hydroxide monohydrate were weighed to achieve Li/(Ni+Mn+Co)=1.0, followed by mixing of the weighed matter by a planetary kneader. This mixture was charged into a pot made of alumina, and with flow of dry air, the temperature thereof was raised to 850° C. at a temperature rising rate of 100° C./hr, held at 850° C. for 15 hours, cooled down to 200° C. at a cooling rate of 100° C./hr, and then left to be cooled. The obtained powder was sieved to a size of 75 μm or less to obtain a powder of lithium/nickel/manganese/cobalt complex oxide. As a result of X-ray diffractometry, it was confirmed that the obtained powder had a monophase having a layered rock salt type crystal structure. ICP measurement resultingly showed confirmation of a LiNi_{0.42}Mn_{0.42}Co_{0.16}O₂ composition.

Note that those fired oxides used in the following inventive cells and comparative cells, which have various compositions and each having a layered rock salt type crystal structure represented by Liₘ[MnₐNi_{b}Co_{c}O₂], were synthesized by adjusting molar ratios of the transition metal compounds used for fabrication of the starting material solutions.

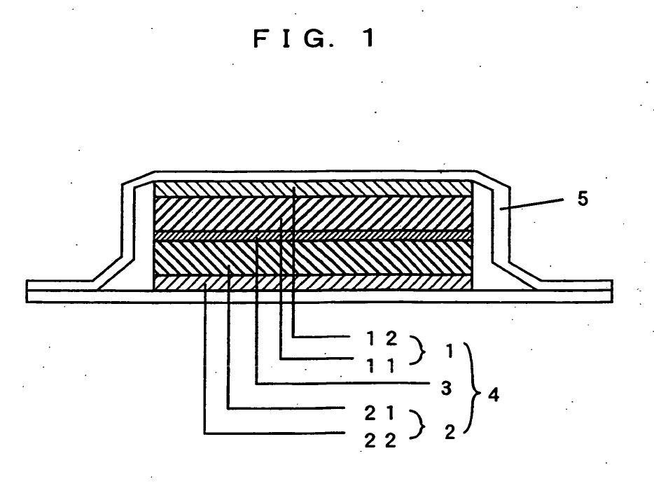

FIG. 1 is a cross-sectional view of a nonaqueous electrolyte cell used in this Example. The nonaqueous electrolyte cell in this Example is constituted of: an electrode group 4 comprising a positive electrode 1, a negative electrode 2, and a separator 3; a nonaqueous electrolyte; and a metal/resin laminate film 5. The positive electrode 1 comprises a positive electrode current collector 12 and a positive electrode composite 11 coated thereon. Further, the negative electrode 2 comprises a negative electrode current collector 22, and a negative electrode composite 21 coated thereon. The electrode group 4 is impregnated with a nonaqueous electrolyte. The metal/resin laminate film 5 covers the electrode group 4, and is sealed all around it by heat-welding.

There will be explained a method for fabricating the nonaqueous electrolyte cell of the above constitution used in this Example.

The positive electrode 1 was obtained as follows. Firstly, there were mixed a positive-electrode active material, acetylene black as an electroconductive material, and an N-methyl-2-pyrrolidone solution of polyvinylidene fluoride as a binder, and this mixture was coated onto one side of the positive electrode current collector 12 comprising an aluminum foil, followed by drying and pressing in a manner to obtain the positive electrode composite 11 having a thickness of 0.1 mm. The positive electrode 1 was obtained by the above process.

Further, the negative electrode 2 was obtained as follows. Firstly, there were mixed graphite as a negative-electrode active material, and an N-methyl-2-pyrrolidone solution of polyvinylidene fluoride as a binder, and this mixture was coated onto one side of the negative electrode current collector 22 comprising a copper foil, followed by drying and pressing in a manner to obtain the negative electrode composite 21 having a thickness of 0.1 mm. The negative electrode 2 was obtained by the above process.

The separator 3 was obtained as follows. Firstly, there was prepared an ethanol solution including 3 wt. % of bi-functional acrylate monomer having a structure represented by (chemical formula 5), the solution was coated onto a polyethylene fine porous membrane (averaged pore diameter of 0.1 μm, pore ratio of 50%, thickness of 23 μm, weight of 12.52 g/m², and air permeability of 89 second/100 ml) as a porous substrate, followed by cross-linking of the monomer by irradiation of electron beam to thereby form an organic polymer layer which was then dried at a temperature of 60° C. for 5 minutes. The separator 3 was obtained by the above process. Note that the obtained separator 3 had a thickness of 24 μm, a weight of 13.04 g/m², an air permeability of 103 second/100 ml, the organic polymer layer had a weight of about 4 wt. % relative to the weight of the porous material, and the cross-linked material layer had a thickness of about 1 μm, so that the pores of the porous substrate were substantially kept as they were.

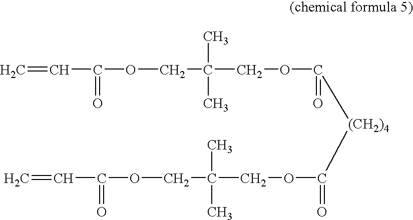

The electrode group 4 was constituted by opposing the positive electrode composite 11 and the negative electrode composite 21 to each other with the separator 3 interposed therebetween, and stacking them in an order of the positive electrode 1, separator 3, and negative electrode 2.

Next, the electrode group 4 was immersed into a nonaqueous electrolyte so that the electrode group 4 was impregnated with the nonaqueous electrolyte. Further, the electrode group 4 was covered by the metal/resin laminate film 5 which was then sealed all around it by heat-welding.

The nonaqueous electrolyte cell was obtained by the above-mentioned fabrication manner with a design capacity of 100 mAh, by using: the nonaqueous electrolyte obtained by dissolving 1 mole of LiPF₆ in 1 liter of a mixed solvent of ethylene carbonate, propylene carbonate, and diethyl carbonate at a volume ratio of 6:2:2, and by further mixing thereinto 2 wt. % of vinylene carbonate and 2 wt. % of 1,3-propane sultone; and a fired oxide as the positive-electrode active material, represented by a composition formula of LiMn_{0.5}Ni_{0.5}O₂ for which a monophase of a layered rock salt type crystal structure was confirmed by X-ray diffractometry. This is regarded as an inventive cell 1.

### EXAMPLE 2

There was obtained a nonaqueous electrolyte cell by the above-mentioned fabrication method with a design capacity of 100 mAh, by using: the same nonaqueous electrolyte as that used in Example 1; and a fired oxide as a positive-electrode active material, represented by a composition formula of LiMn_{0.42}Ni_{0.42}Co_{0.16}O₂ for which a monophase of a layered rock salt type crystal structure was confirmed by X-ray diffractometry. This is regarded as an inventive cell 2.

### EXAMPLE 3

There was obtained a nonaqueous electrolyte cell by the above-mentioned fabrication manner with a design capacity of 100 mAh, by using: the nonaqueous electrolyte obtained by dissolving 1 mole of LiPF₆ in 1 liter of a mixed solvent of ethylene carbonate, propylene carbonate, and diethyl carbonate at a volume ratio of 6:2:2, and by further mixing thereinto 2 wt. % of catechol carbonate and 2 wt. % of sulfolane; and a fired oxide as the positive-electrode active material, represented by a composition formula of LiMn_{0.33}Ni_{0.33}Co_{0.34}O₂ for which a monophase of a layered rock salt type crystal structure was confirmed by X-ray diffractometry. This is regarded as an inventive cell 3.

### EXAMPLE 4

There was obtained a nonaqueous electrolyte cell by the above-mentioned fabrication manner with a design capacity of 100 mAh, by using: the nonaqueous electrolyte obtained by dissolving 1 mole of LiPF₆ in 1 liter of a mixed solvent of ethylene carbonate, propylene carbonate, and diethyl carbonate at a volume ratio of 6:2:2, and by further mixing thereinto 2 wt. % of vinylene carbonate and 2 wt. % of 1,4-butane sultone; and a fired oxide as the positive-electrode active material, represented by a composition formula of LiMn_{0.25}Ni_{0.25}Co_{0.5}O₂ for which a monophase of a layered rock salt type crystal structure was confirmed by X-ray diffractometry. This is regarded as an inventive cell 4.

### COMPARATIVE EXAMPLE 1

There was obtained a nonaqueous electrolyte cell by the above-mentioned fabrication method with a design capacity of 100 mAh, by using: the same nonaqueous electrolyte as that used in Example 1; and LiCoO₂ as a positive-electrode active material. This is regarded as a comparative cell 1.

### EXAMPLE 5

There was obtained a nonaqueous electrolyte cell by the above-mentioned fabrication method with a design capacity of 100 mAh, by using: the same nonaqueous electrolyte as that used in Example 1; and a fired oxide as a positive-electrode active material, represented by a composition formula of LiMn_{0.17}Ni_{0.17}Co_{0.67}O₂ for which a monophase of a layered rock salt type crystal structure was confirmed by X-ray diffractometry. This is regarded as an inventive cell 5.

### EXAMPLE 6

There was obtained a nonaqueous electrolyte cell by the above-mentioned fabrication method with a design capacity of 100 mAh, by using: the same nonaqueous electrolyte as that used in Example 1; and a fired oxide as a positive-electrode active material, represented by a composition formula of LiMn_{0.08}Ni_{0.08}Co_{0.84}O₂ for which a monophase of a layered rock salt type crystal structure was confirmed by X-ray diffractometry. This is regarded as an inventive cell 6.

### EXAMPLE 7

There was obtained a nonaqueous electrolyte cell by the above-mentioned fabrication method with a design capacity of 100 mAh, by using: the same nonaqueous electrolyte as that used in Example 1; and a fired oxide as a positive-electrode active material, represented by a composition formula of LiMn_{0.05}Ni_{0.05}Co_{0.9}O₂ for which a monophase of a layered rock salt type crystal structure was confirmed by X-ray diffractometry. This is regarded as an inventive cell 7.

### EXAMPLE 8

There was obtained a nonaqueous electrolyte cell by the above-mentioned fabrication manner with a design capacity of 100 mAh, by using: the nonaqueous electrolyte obtained by dissolving 1 mole of LiPF₆ in 1 liter of a mixed solvent of ethylene carbonate, propylene carbonate, and diethyl carbonate at a volume ratio of 6:2:2, and by further mixing thereinto 2 wt. % of vinylethylene carbonate and 2 wt. % of ethylene sulfite; and a fired oxide as the positive-electrode active material, represented by a composition formula of LiMn_{0.30}Ni_{0.55}Co_{0.15}O₂ for which a monophase of a layered rock salt type crystal structure was confirmed by X-ray diffractometry. This is regarded as an inventive cell 8.

### COMPARATIVE EXAMPLE 2

There was obtained a nonaqueous electrolyte cell by the above-mentioned fabrication manner with a design capacity of 100 mAh, by using: the nonaqueous electrolyte obtained by dissolving 1 mole of LiPF₆ in 1 liter of a mixed solvent of ethylene carbonate, propylene carbonate, and diethyl carbonate at a volume ratio of 6:2:2, and by further mixing thereinto 2 wt. % of vinylene carbonate; and the same fired oxide as a positive-electrode active material, as that used in Example 2. This is regarded as a comparative cell 2.

### COMPARATIVE EXAMPLE 3

There was obtained a nonaqueous electrolyte cell by the above-mentioned fabrication manner with a design capacity of 100 mAh, by using: the same nonaqueous electrolyte as that used in Comparative Example 2; and the same fired oxide as a positive-electrode active material, as that used in Example 3. This is regarded as a comparative cell 3.

### COMPARATIVE EXAMPLE 4

There was obtained a nonaqueous electrolyte cell by the above-mentioned fabrication manner with a design capacity of 100 mAh, by using: the same nonaqueous electrolyte as that used in Comparative Example 2; and the same fired oxide as a positive-electrode active material, as that used in Example 4. This is regarded as a comparative cell 4.

### COMPARATIVE EXAMPLE 5

There was obtained a nonaqueous electrolyte cell by the above-mentioned fabrication manner with a design capacity of 100 mAh, by using: the same nonaqueous electrolyte as that used in Comparative Example 2; and LiCoO₂ as a positive-electrode active material. This is regarded as a comparative cell 5.

### COMPARATIVE EXAMPLE 6

There was obtained a nonaqueous electrolyte cell by the above-mentioned fabrication manner with a design capacity of 100 mAh, by using: the same nonaqueous electrolyte as that used in Comparative Example 2; and the same fired oxide as a positive-electrode active material, as that used in Example 5. This is regarded as a comparative cell 6.

### COMPARATIVE EXAMPLE 7

There was obtained a nonaqueous electrolyte cell by the above-mentioned fabrication manner with a design capacity of 100 mAh, by using: the same nonaqueous electrolyte as that used in Comparative Example 2; and the same fired oxide as a positive-electrode active material, as that used in Example 6. This is regarded as a comparative cell 7.

(Initial Charge/Discharge Test)

There was conducted an initial charge/discharge test for each of inventive cells 1 through 8 and comparative cells 1 through 7. Namely, there was obtained an initial charge capacity, by conducting a constant-current constant-voltage charge at an electric current of 20 mA and a final voltage of 4.2V at 20° C. Next, there was conducted a constant-current discharge at an electric current of 20 mA and a final voltage of 2.7V at 20° C., thereby obtaining an initial discharge capacity. Defined as an “initial discharge capacity (%)” is a ratio (percentage) of the initial discharge capacity to a design capacity (100 mAh).

Further defined as “initial efficiency (%)” is a ratio (percentage) of the initial discharge capacity to the initial charge capacity.

(High-Temperature Charge/Discharge Cycle Performance Test)

Subsequently, there was conducted a charge/discharge cycle test in a high-temperature environment at a temperature of 50° C. The charge conditions and discharge conditions were the same as those in the above. Defined as a “high-temperature charge/discharge cycle performance (%)” is a ratio (percentage) of: a discharge capacity at a 200-th cycle counted from the initial discharge; to the initial discharge capacity.

(High-Temperature Storage Test)

There was conducted a high-temperature storage test for each of the inventive cells 1 through 8 and comparative cells 1 through 7 which were fabricated separately. Firstly, the above-mentioned initial charge/discharge test was conducted to confirm an initial discharge capacity, then charge was conducted under the same conditions as the above, the applicable cell was stored in an environment at a temperature of 60° C. over 30 days, and the cell was brought back to 20° C., followed by discharge under the same conditions as the above, thereby obtaining a self-discharge ratio of the cell. Note that the self-discharge ratio is calculated by the following equation 1:
(self-discharge ratio)=[1-(discharge capacity after high-temperature storage)/(discharge capacity before high-temperature storage)]×100 (Equation 1)

Results of the cell tests are shown in Table 1 and Table 2.

TABLE 1

| | | | | | High- | Post high- |
|---|---|---|---|---|---|---|
| Presence of | Value of c | Value of b | initial | | temperature | temperature |
| (cyclic organic | in general | in general | discharge | Initial | charge/dis- | storage |
| compound having | formula | formula | capacity | efficiency | charge cycle | self-discharge |
| S═O bond) | Liₘ[MnₐNi_{b}Co_{c}O₂] | Liₘ[Ni_{b}M_{(1-b)}O₂] | % | % | performance % | ratio % |
| Ex. 1 | 0 | 0.5 | 96 | 80 | 80 | 16 |
| Ex. 2 | 0.16 | 0.42 | 97 | 85 | 87 | 10 |
| Ex. 3 | 0.34 | 0.33 | 98 | 88 | 82 | 15 |
| Ex. 4 | 0.5 | 0.25 | 98 | 89 | 78 | 17 |
| Com. Ex. 1 | 1 | 0 | 99 | 91 | 65 | 20 |
| Ex. 5 | 0.67 | 0.17 | 98 | 89 | 78 | 17 |
| Ex. 6 | 0.84 | 0.08 | 98 | 89 | 76 | 17 |
| Ex. 7 | 0.9 | 0.05 | 99 | 91 | 67 | 18 |
| Ex. 8 | — | 0.55 | 95 | 83 | 80 | 12 |

TABLE 2

| | | | | | High- | Post high- |
|---|---|---|---|---|---|---|
| Absence of | Value of c | Value of b | Initial | | temperature | temperature |
| (cyclic organic | in general | in general | discharge | Initial | charge/dis- | storage |
| compound having | formula | formula | capacity | efficiency | charge cycle | self-discharge |
| S═O bond) | Liₘ[MnₐNi_{b}Co_{c}O₂] | Liₘ[Ni_{b}M_{(1-b)}O₂] | % | % | performance % | ratio % |
| Com. Ex. 2 | 0.16 | 0.42 | 96 | 85 | 63 | 25 |
| Com. Ex. 3 | 0.34 | 0.33 | 97 | 88 | 63 | 25 |
| Com. Ex. 4 | 0.5 | 0.25 | 98 | 88 | 61 | 24 |
| Com. Ex. 5 | 1 | 0 | 99 | 90 | 58 | 38 |
| Com. Ex. 6 | 0.67 | 0.17 | 89 | 88 | 61 | 25 |
| Com. Ex. 7 | 0.84 | 0.08 | 98 | 89 | 60 | 24 |

In each of the inventive cells and comparative cells, there were obtained an initial discharge capacity which was substantially 100% of a design capacity, and a charge/discharge efficiency of about 80% or more.

Here, when the inventive cell 2 adopting a fired oxide where |a-b|=0 and c=0.16 in the composition formula Liₘ[MnₐNi_{b}Co_{c}O₂] is compared with the comparative cell 2 concerning the performances in the high-temperature charge/discharge cycle test and the post high-temperature storage self-discharge ratio, the inventive cell 2 adopting the nonaqueous electrolyte according to the present invention is remarkably improved as compared with the comparative cell 2 failing to adopt the nonaqueous electrolyte according to the present invention.

In case of similar comparison of the comparative cell 1 with the comparative cell 5 each adopting LiCoO₂ as a positive-electrode active material where c=1 in the composition formula Liₘ[MnₐNi_{b}Co_{c}O₂, the comparative cell 1 is more excellent than the comparative cell 5. However, the effect is not necessarily remarkable. From this fact, it can be understood that a particularly excellent effect is exhibited by the nonaqueous electrolyte cell as a feature of the present invention in case of adopting a fired oxide having a layered rock salt type crystal structure represented by Liₘ[MnₐNi_{b}Co_{c}O₂] (0≦m≦1.1, a+b+c=1, |a-b|≦0.05, a≠0, b≠0) in which the value of c is 0≦c<1.

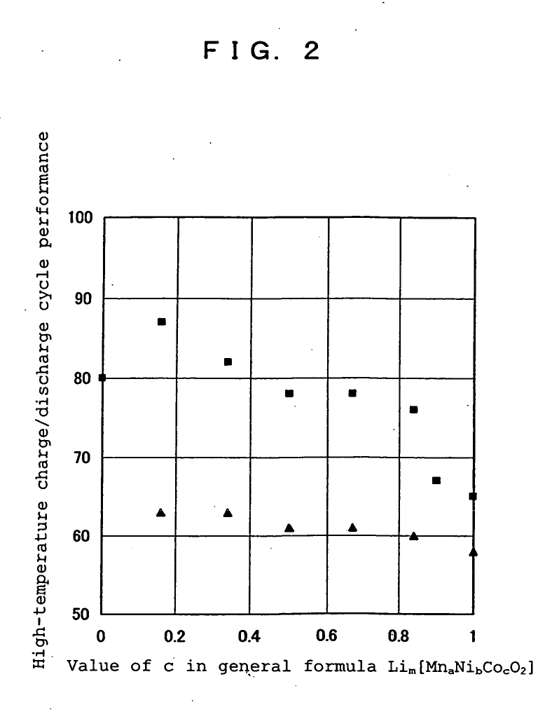

FIG. 2 is a graph having an abscissa plotting a value of c in Liₘ[MnₐNi_{b}Co_{c}O₂] (0≦m≦1.1, a+b+c=1, |a-b|≦0.05, a≠0, b≠0), and an ordinate plotting a high-temperature charge/discharge cycle performance, concerning the inventive cells 1 through 7 and comparative cells 1 through 7. Closed boxes represent the inventive cells 1 through 7, and comparative cell 1, respectively, and closed triangles represent the comparative cells 2 through 7, respectively.

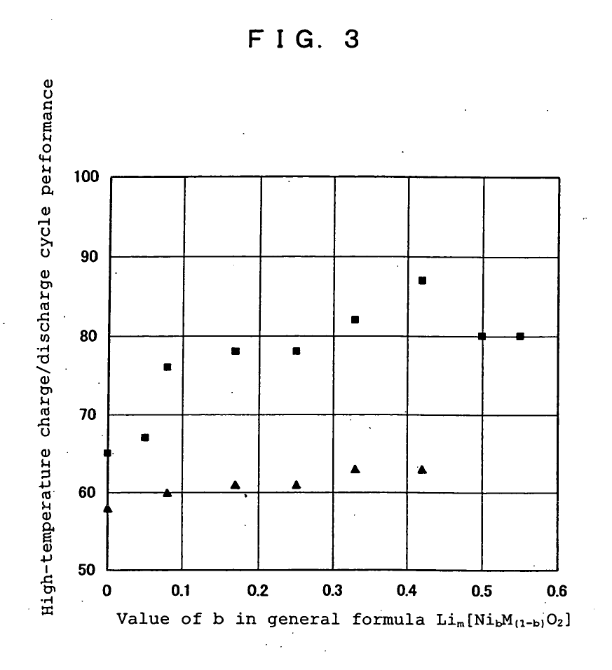

FIG. 3 is a graph having an abscissa plotting a value of b in Liₘ[Ni_{b}M_{(1-b)}O₂ (M is Mn, or Mn and Co, and 0≦m≦1.1), and an ordinate plotting a high-temperature charge/discharge cycle performance, concerning the inventive cells 1 through 8 and comparative cells 1 through 7. Closed boxes represent the inventive cells 1 through 8, and comparative cell 1, respectively, and closed triangles represent the comparative cells 2 through 7, respectively.

In view of these results, it can be understood that the value of c is preferably within a range of 0≦c<1 in a fired oxide having a layered rock salt type crystal structure represented by Liₘ[MnₐNi_{b}Co_{c}O₂] (0≦m≦1.1, a+b+c=1, |a-b|≦0.05, a≠0, b≠0) from standpoints of a high-temperature charge/discharge cycle performance and a post high-temperature storage self-discharge ratio, such that 0<c≦0.84 is preferable since the effect of the present invention can be remarkably recognized, 0<c≦0.5 is more preferable since the effect of the present invention can be more remarkably recognized, and 0<c<0.34 is most preferable since the effect of the present invention can be most remarkably recognized.

In view of these results, it can be understood that the value of b is preferably within a range of 0.08≦b<0.55 in a fired oxide having a layered rock salt type crystal structure represented by Liₘ[Ni_{b}M_{(1-b)}O₂] (M is Mn, or Mn and Co, and 0≦m≦1.1) from standpoints of a high-temperature charge/discharge cycle performance and a post high-temperature storage self-discharge ratio, such that 0.25≦b≦0.55 is more preferable since the effect of the present invention can be more remarkably recognized, and 0.33<b<0.55 is most preferable since the effect of the present invention can be most remarkably recognized.

Note that although the above-mentioned Examples have exemplarily adopted sulfolane, 1,3-propane sultone, and 1,4-butane sultone as cyclic organic compounds each having an S═O bond, respectively, there have been confirmed the same effects also in case of adoption of ethylene sulfite, propylene sulfite, and sulfolene.

Further, although the above-mentioned Examples have exemplarily adopted vinylene carbonate and catechol carbonate as cyclic carbonates each having a carbon-carbon π bond, there have been confirmed the same effects also in case of adoption of styrene carbonate, vinylethylene carbonate, 1-phenylvinylene carbonate, and 1,2-diphenylvinylene carbonate.

Moreover, although the above-mentioned Examples have exemplarily adopted ethylene carbonate and propylene carbonate as cyclic carbonates each without a carbon-carbon π bond, there have been confirmed the same effects also in case of adoption of butylene carbonate.

The invention may be practiced in other various forms without departing from the spirit or essential features thereof. Thus, the above described embodiments or Examples are considered to be illustrative and not restrictive in all respects. The scope of the invention is indicated by the claims rather than by the description. Further, all changes and modifications within a range equivalent to those of the claims fall within the scope of the present invention.

### INDUSTRIAL APPLICABILITY

The nonaqueous electrolyte cell according to the present invention as described above is excellent in cell performance in a high-temperature environment, and is therefore useful as electric-power sources for electronic equipments, electric-power sources for electric power storage, electric-power sources for electric vehicles, and the like, to be used in a high-temperature environment.

1. A nonaqueous electrolyte cell comprising a positive electrode and a negative electrode, and produced by using a nonaqueous electrolyte including at least one kind of a cyclic carbonate having a carbon-carbon π bond and at least one kind of a cyclic organic compound having an S═O bond, characterized in
that said positive electrode is constituted of a positive-electrode active material including a main component which is a fired oxide having a layered rock salt type crystal structure represented by Liₘ[Ni_{b}M_{(1-b)}O₂] (M is one or more kinds of elements included in 1 to 16 groups excluding Ni, Li, and O; and 0≦m≦1.1), and in which the value of b is 0<b<1.

2. The nonaqueous electrolyte cell of claim 1, characterized in that the value of b is 0.08≦b≦0.55.

3. The nonaqueous electrolyte cell of claim 2, characterized in that the value of b is 0.25≦b≦0.55.

4. The nonaqueous electrolyte cell of claim 1, characterized in that the M is Mn, or Mn and Co.

5. The nonaqueous electrolyte cell of claim 4, characterized in that said fired oxide has a layered rock salt type crystal structure represented by Liₘ[MnₐNi_{b}Co_{c}O₂] (0≦m≦1.1, a+b+c=1, |a-b|≦0.05, a≠0, b≠0) in which the value of c is 0≦c<1.

6. The nonaqueous electrolyte cell of claim 5, characterized in that the value of c is 0<c≦0.84.

7. The nonaqueous electrolyte cell of claim 6, characterized in that the value of c is 0<c≦0.5.

8. The nonaqueous electrolyte cell of any one of claims 1 through 7, characterized in that said cyclic organic compound having an S═O bond has a structure represented by any one of (chemical formula 1) through (chemical formula 4):

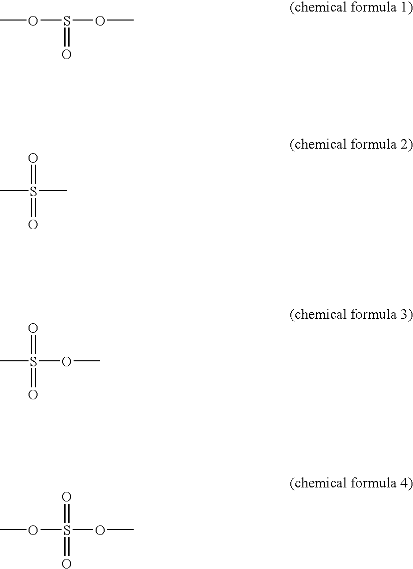

9. The nonaqueous electrolyte cell of claim 8, characterized in that said cyclic organic compound having an S═O bond is at least one kind selected from among ethylene sulfite, propylene sulfite, sulfolane, sulfolene, 1,3-propane sultone, 1,4-butane sultone, and derivatives thereof.

10. The nonaqueous electrolyte cell of any one of claims 1 through 7, characterized in that said cyclic carbonate having a carbon-carbon π bond is at least one kind selected from among vinylene carbonate, styrene carbonate, catechol carbonate, vinylethylene carbonate, 1-phenylvinylene carbonate, and 1,2-diphenylvinylene carbonate.

11. The nonaqueous electrolyte cell of any one of claims 1 through 7, characterized in that said nonaqueous electrolyte includes a cyclic carbonate without carbon-carbon π bonds.

12. The nonaqueous electrolyte cell of claim 11, characterized in that said cyclic carbonate without carbon-carbon π bonds is at least one kind selected from among ethylene carbonate, propylene carbonate, and butylene carbonate.

13. The nonaqueous electrolyte cell of any one of claims 1 through 7, characterized in that said main component of said negative-electrode active material constituting said negative electrode is graphite.
